(19) United States
(12) Patent Application Publication
(10) Pub. No.: US 2014/0318383 A1
(43) Pub. Date: Oct. 30, 2014

(54) Toasting Apparatus Having Improved Hot Chamber Isolation With Passive Ventilation

(71) Applicant: Eksen Makine Sanayi ve Ticaret, A.S., Gebze, Kocaeli (TR)

(72) Inventor: Besim Tahincioglu, Gebze (TR)

(21) Appl. No.: 14/356,352

(22) PCT Filed: Oct. 8, 2012
(86) PCT No.: PCT/EP2012/069837

§ 371 Date: May 5, 2014

(30) Foreign Application Priority Data
Oct. 6, 2011 (EP) 11184219.1

(51) Int. Cl. A47J 37/06

(52) U.S. Cl. CPC A47J 37/0611
USPC 99/372

(57) ABSTRACT

The present invention proposes a domestic appliance and specifically an electrical toaster (11) having a pair of heating plates (12, 13) in thermal communication with heat sources (19, 20) accommodated to transfer heat to said plates (12, 13). Grilling plates (12, 13) are typically positioned in the manner that a lower plate (12) lies horizontally in a stationary manner and an upper plate (13) is hinged to be rotatable relative to said lower plate (12) to be closed upon the same in order for forming a grilling chamber enclosing a food article from below and above. An electrical toaster (11) in which a passive ventilation system discharging accumulated heat through convenient openings (18) before heating plates (12, 13) with which users can directly get in contact becomes heated is provided.

### TECHNICAL FIELD OF THE INVENTION

The present invention relates to an electrical household appliance and more particularly to a toaster having plates to brown a food article and particularly slices of bread by exposure to heat.

### BACKGROUND OF THE INVENTION

Toasters are widely used all over the world. A toaster of the present type generally has a pair of hinged grilling plates receiving food article between them. The upper grilling plate being rotatable with respect to the lower grilling plate, when closed, defines a heating chamber for grilling a food article, for instance slices of bread.

A common problem with the grilling appliances of the present type is that users generally need to pay attention to the fact that the apparatus' outer surfaces may become substantially hot in a matter of minutes and one should not touch the outer surface of the body inadvertently.

The present invention on the other hand, distinguishes from the prior art in that separated hot and cold zones are provided within the toasting apparatus to prevent accidents when a user inadvertently touches the outer surface of the apparatus body.

To that end, the present invention provides a passive ventilation system discharging accumulated heat through convenient openings before heating plates with which users can directly get in contact, becomes heated. Elimination of burning hazards is therefore ensured to a substantial degree especially in cases where children or elder people with or without low vision condition are left alone to operate the toasting apparatus.

Passive ventilation typically involves convective fluid channels to enable cooling of the apparatus without making use of separate heat discharge means involving energy consumption. The present invention therefore addresses a quite simple and very known yet untouched problem in a simple but efficient way.

Excessive heating of the grilling plates are especially in question in cases where both plates hinged to each other are opened 180 degrees apart in a manner to form a generally planar grilling surface while the toasting apparatus is disposed on a flat surface such as a kitchen counter or table. In this case as there is excessive heat loss to the ambient air due to the grilling surface being formed by a single-side heat source instead of a double-side closed heat chamber formed by lower and upper grill plates, effective active power dissipated by the electrical resistances associated by said grilling pates must be elevated to compensate heat losses, therefore resulting in considerably hotter outer surfaces posing a burn injury threat to users and a fire risk in the kitchen. To that end, the apparatus of the present invention is advantageous in that using the same in horizontally disposed open position is more secure in terms of elevated nominal temperature values on the grilling plates' outer surfaces.

A prior art reference pertinent to the preamble of claim 1 is the French patent application FR 2956573 A1. The document, not disclosing a toasting apparatus but a waffle baker requires a substantially lower amount of heat energy to prepare waffle, therefore requiring no special arrangements for eliminating hotter outer surfaces as no excessive heating occurs. The prior art reference, does not explicitly disclose special fluid zones as a heat barrier against excessive heating of hinged grilling plates since no burn injury threat is in question as in the case where meat products are grilled with much higher heat energy.

### OBJECTS OF THE INVENTION

Primary object of the present invention is to provide an electrical toaster in which hot and cold zones are provided to prevent excessive heating of the outer surface of the apparatus body.

Another object of the present invention is to provide an electrical toaster in which burning hazards are prevented when a user inadvertently touches the outer surface of the apparatus body.

Another object of the present invention is to provide an electrical toaster in which a passive ventilation system discharging accumulated heat through convenient openings before heating plates with which users can directly get in contact becomes heated is provided.

Another object of the present invention is to provide an electrical toaster use of which is more secure in horizontally disposed open position in terms of elevated nominal temperature values on the grilling plates' outer surfaces.

### SUMMARY OF THE INVENTION

The present invention proposes a domestic appliance and specifically an electrical toaster having a pair of heating plates in thermal communication with heat sources accommodated to transfer heat to said plates. Grilling plates are typically positioned in the manner that a lower plate lies horizontally in a stationary manner and an upper plate is hinged to be rotatable relative to said lower plate to be closed upon the same in order for forming a grilling chamber enclosing a food article from below and above. An electrical toaster in which a passive ventilation system discharging accumulated heat through convenient openings before heating plates with which users can directly get in contact becomes heated is provided.

### BRIEF DESCRIPTION OF THE FIGURES

The figures whose brief explanation is herewith provided is solely intended for providing a better understanding of the present invention and is as such not intended to define the scope of protection or the context in which said scope is interpreted in the absence of the description.

FIG. 1 demonstrates a general perspective view of the toasting apparatus according to the present invention where the grilling plates are shown laterally.

FIG. 2 demonstrates a general perspective view of the toasting apparatus according to the present invention.

FIG. 3 demonstrates a side view of the toasting apparatus according to the present invention where the grilling plates are shown.

FIG. 4a demonstrates the G-G cross-section of the toasting apparatus according to the present invention as indicated in FIG. 4b. FIG. 4c demonstrates the H detail as indicated in FIG. 4a.

FIG. 5 demonstrates a perspective view of the upper grilling part of the toasting apparatus according to the present invention.

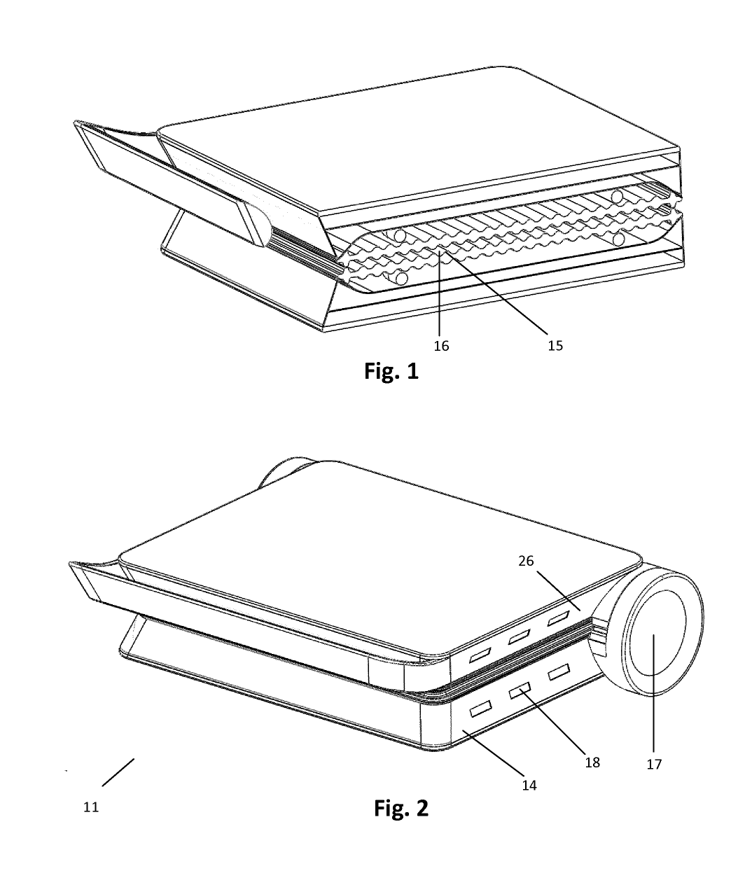

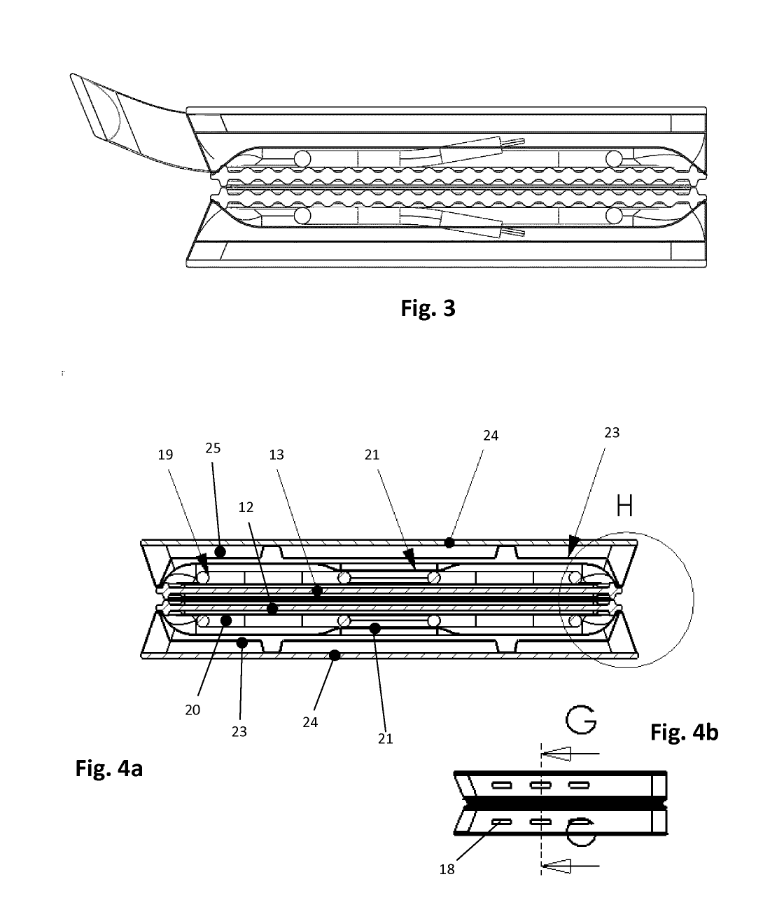

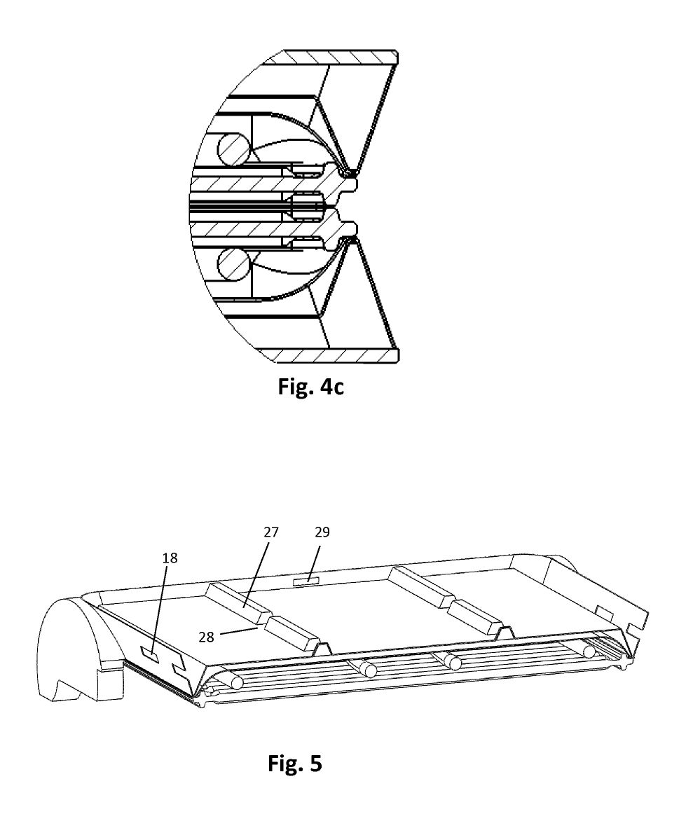

### DETAILED DESCRIPTION OF THE INVENTION

Referring now to the figures outlined above, the present invention proposes an electrical household appliance (11) and namely a toasting apparatus. The apparatus typically features a lower plate (12) stationary on a base part (14), the latter housing control electronics and driving mechanisms as will be explained hereinafter.

The upper grilling plate (13) in a movable part (26) according to the present invention is typically hinged by a hinge mechanism (17) to the lower grilling plate (12) in a manner to be rotatable relative to said lower plate (12). The upper grilling plate (13) is therefore adapted to be closed upon sad lower grilling (12) plate in a closed grilling position so as to provide a grilling chamber ( )in which a food article being in contact with said plates (12, 13) from above and below.

The grilling plates (12, 13) are typically designed in the form to have parallel protrusions (15) forming circular cross-section channels (16) extending between lateral edges of the apparatus (11) in closed position.

A control panel (typically provides users with different grilling options for instance to allow a longer grilling period. A user therefore setting a timer to a specified duration of grilling time of preference will energize heat sources being electric resistances of conventional tubular type. Those are provided within the upper and lower plate housings (respectively 19, 20). Upon completion of specified duration of time, powering of resistances (19, 20) will discontinue as set by the user.

The present invention provides an improved hot grilling chamber construction as explained below. A radiant element (21) in the form of a heat barrier, typically reflects back convective heat energy to the grilling plates (12, 13) and hence to the grilling chamber. Said radiant elements (21) are disposed in between each of said grilling plates (12, 13) and a generally planar intermediate body (23) in association with respective upper and lower grilling portions. Further an outermost planar part, in the form of a cover (24) is disposed. It is to be noted that said planar intermediate body (23) can be made out of metal sheet or Bakelite, a well-known trademark of a material known to the person skilled in the art. Further, said outermost covers (24) can be made out of metal sheet or glass.

The present invention further features ventilation openings (18) laterally disposed on the side edges of said base part (14) and said movable part (26). Said ventilation openings (18) are in communication with cold zones (25) in between said planar intermediate bodies (23) and said covers (24) in each of base part (14) and said movable part (26). To this end, heat energy present in the vicinity of said electrical resistances (19, 20) in the direction of said radiant elements (21) in each part (14, 26) is first reflected back to the grilling plates (12, 13) and a further portion of the heat energy is discharged through said ventilation openings (18) being in fluid communication with said cold zones (25).

The core approach underlying the invention, that is, provision of separate temperature zones along with passive ventilation channels may be accomplished for instance by means of various divisions incorporating said hot and cold zone and various passive cooling lines on said apparatus body.

In a nutshell, the present invention proposes an electrical toasting apparatus (11) comprising a horizontally lying stationary lower grilling plate (12) in a base part (14) and an upper grilling plate (13) in a movable part. Said upper grilling plate (13) is hingedly mounted on said lower plate (12) in the manner to be closed upon said lower plate (12) to form a grilling chamber between said plates (12, 13). Said base part (14) and said movable part (26) comprise electrical resistances (19, 20) in thermal communication with said upper (13) and lower (12) grilling plates.

Said toasting apparatus (11) comprises radiant elements (21) respectively in association with said lower and upper grilling plates (12, 13) to be extending parallel to said grilling plates (12, 13) to cover the entire surfaces thereof in the manner to accommodate said electrical resistances (19, 20) thereinbetween. Said radiant elements (21) are disposed in between each of said grilling plates (12, 13) and planar intermediate bodies (23) in association with respective upper and lower grilling portions.

The planar intermediate body (23) according to the invention comprises elevated channels (27) extending perpendicular to the hinge mechanism (17) axis. Said elevated channels (27) also support said cover elements (24) in a non-spaced manner. Said elevated channels (27) are further provided with fluid passages (28) to allow fluid communication in the direction of side openings (18) within said cool zone (25).

Said cool zone (25) further comprises rear windows (29) extending parallel to the axis of said hinge mechanism (17).

1-8. (canceled)

9. An electrical toasting apparatus (11) comprising a horizontally lying stationary lower grilling plate (12) in a base part (14), an upper grilling plate (13) in a movable part (26) hingedly mounted on said lower plate (12) in the manner to be closed upon said lower plate (12) to form a grilling chamber between said plates (12, 13), electrical resistances (19, 20) in thermal communication with said upper (13) and lower (12) grilling plates, said toasting apparatus (11) further comprising radiant elements (21) respectively in association with said lower and upper grilling plates (12, 13) to be extending parallel to said grilling plates (12, 13) to cover the entire surfaces thereof in the manner to accommodate said electrical resistances (19, 20) thereinbetween, said radiant elements (21) being disposed in between each of said grilling plates (12, 13) and planar intermediate bodies (23) respectively in association with said base part (14) and said movable part (26), said planar intermediate body (23) is made out of either metal sheet or Bakelite, and said planar intermediate bodies (23) comprises elevated channels (27).

10. An electrical toasting apparatus (11) as in claim 9 wherein said planar intermediate bodies (23) between said radiant elements (21) and cover elements (24) respectively in association with said base part (14) and said movable part (26) define a cold zone (25).

11. An electrical toasting apparatus (11) as in claim 10 wherein said cold zones (25) are in fluid communication with ventilation openings (18) laterally disposed on the side edges of said base part (14) and said movable part (26) extending perpendicular to the hinge mechanism (17) axis.

12. An electrical toasting apparatus (11) as in claim 9 wherein said upper (13) and lower (12) grilling plates comprise parallel protrusions (15) forming circular cross-section channels (16) extending between lateral edges of said toasting apparatus (11) in closed position whereby grilling attachment (21) is suitable to be placed along said circular cross-section channels (16) of the upper (13) and lower (12) grilling plates.

13. An electrical toasting apparatus (11) as set forth in claim 9 wherein said covers (24) are made out of either metal sheet or glass material.

14. An electrical toasting apparatus (11) as set forth in claim 9 wherein said elevated channels (27) are provided with fluid passages (28) to allow fluid communication in the direction of side openings (18) within said cold zone (25).

15. An electrical toasting apparatus (11) as set forth in claim 14 wherein said cold zone (25) comprises at least one rear window (29) extending parallel to the axis of said hinge mechanism (17).
